(19) United States
(12) Patent Application Publication
(10) Pub. No.: US 2025/0292474 A1
(43) Pub. Date: Sep. 18, 2025

(54) PHOTO FRAME AND EXHIBITION METHOD BASED ON PHOTO FRAME

(71) Applicant: Shenzhen Qianhai Hand-painted Technology and Culture Co. Ltd., Shenzhen (CN)

(72) Inventor: Bo WEI, Shenzhen (CN)

(21) Appl. No.: 18/785,942

(22) Filed: Jul. 26, 2024

(30) Foreign Application Priority Data
Mar. 15, 2024 (CN) 202410296698.X

(51) Int. Cl. G06T 13/20; G06T 13/40; G10L 15/02; G10L 15/06; G10L 15/18; G10L 15/22

(52) U.S. Cl. CPC G06T 13/205; G06T 13/40; G10L 15/02; G10L 15/063; G10L 15/1815; G10L 15/22

(57) ABSTRACT

The present disclosure discloses a photo frame, and an exhibition method based on the photo frame. A frame body of the photo frame includes a display module, a voice acquisition module, and a processing module. After the photo frame is started, the voice acquisition module picks up voice information of a viewer; the processing module processes a character in a currently displayed portrait based on the voice information to make the character in the portrait interact with the viewer; and the display module displays the portrait in an interaction process. Through a voice technology, photos and paintings are endowed with a more vivid and immersive display experience. The photo frame can recognize displayed picture content and automatically generate corresponding voice description, allowing an audience to have a deeper understanding of a work through auditory and visual means.

### TECHNICAL FIELD

The present application relates to the technical field of image processing, in particular to a photo frame and an exhibition method based on the photo frame.

### BACKGROUND

When exhibiting in an exhibition hall, visual communication of picture information lacks richer expressions, and visitors are limited to limited exhibition experience in understanding of exhibited works.

### SUMMARY

The present application provides a photo frame and an exhibition method based on the photo frame, so as to solve problems existing in the related art.

In a first aspect, the present disclosure provides a photo frame. A frame body of the photo frame includes a display module, a voice acquisition module, and a processing module. After the photo frame is started, the voice acquisition module picks up voice information of a viewer; the processing module processes a character in a currently displayed portrait based on the voice information to make the character in the portrait interact with the viewer; and the display module displays the portrait in an interaction process.

Optionally, processing, by the processing module, the character in the currently displayed portrait based on the voice information to make the character in the portrait interact with the viewer includes: processing the picked-up voice information in the interaction process, so as to determine dialogue response information corresponding to the voice information; and processing the character based on the dialogue response information, so as to drive a mouth of the character for a voice response, and/or to drive limb movement of the character while being accompanied by a language response.

Optionally, processing the character so as to drive the mouth of the character for the voice response, and/or to drive the limb movement of the character while being accompanied by the language response includes: inputting audio information corresponding to the dialogue response information and the character into a trained model, and outputting a character whose character mouth shape is consistent with an audio and whose head action is consistent with the audio, wherein the trained model includes a sub network for generating the head action and a sub network for generating the character mouth shape, and output results of the two sub networks generate a plurality of image frames based on an image translation model.

Optionally, training the sub network for generating the character mouth shape includes: extracting an audio feature from an audio sample and extracting a facial coefficient from a facial image sample; and training by using the audio feature and a preset facial coefficient as inputs, and using facial mouth shape images as outputs, wherein during training, a blink correlation coefficient in the facial coefficient is redirected and introduced as an input into a training process.

Optionally, during training, the facial image sample is input into a preset lip shape action migration algorithm for processing, and a plurality of lip shape image frames are output; and the plurality of lip shape image frames are compared with the plurality of facial mouth shape images, and training is performed with a training goal of a minimum image difference.

Optionally, training the sub network for generating the head action includes: extracting an audio feature from a video sample containing a character head and a human head pose feature; and inputting the audio feature, the head pose feature, and a head coefficient into an encoder, and then inputting the same to a decoder so as to output a plurality of head pose image frames, wherein training is performed with a training goal of a minimum difference between the plurality of head pose images and the input head pose feature; and the head coefficient is determined based on a preset linear adjustment coefficient.

Optionally, determining the dialogue response information corresponding to the voice information includes: performing semantic understanding on the voice information, and calling an intelligent model based on a semantic understanding result to generate the corresponding dialogue response information; and/or, calling preset data mapped to the currently displayed portrait, and modifying the dialogue response information based on the preset data.

Optionally, when the photo frame is started, a starting mode includes: receiving, if a portrait upload component in a human-computer interaction interface of the display module is triggered, an uploaded portrait and displaying the portrait; and waking up the character if the human-computer interaction interface of the display module detects that a wake-up operation of the character in the portrait is triggered, and processing, by the processing module, the character based on the voice information after the voice acquisition module picks up the voice information of the viewer, such that the character interacts with the viewer.

Optionally, when the photo frame is started, a starting mode further includes: receiving, if a video upload component in a human-computer interaction interface of the display module is triggered, an uploaded video and displaying the video.

In a second aspect, the present disclosure provides an exhibition method based on a photo frame, including picking up voice information of a viewer after the photo frame is started; processing a character in a currently displayed portrait based on the voice information to make the character in the portrait interact with the viewer; and displaying the portrait in an interaction process.

The present disclosure discloses the photo frame and the exhibition method based on the photo frame. The frame body of the photo frame includes the display module, the voice acquisition module, and the processing module. After the photo frame is started, the voice acquisition module picks up the voice information of the viewer; the processing module processes the character in the currently displayed portrait based on the voice information to make the character in the portrait interact with the viewer; and the display module displays the portrait in the interaction process. Through a voice technology, photos and paintings are endowed with a more vivid and immersive display experience. The photo frame can recognize displayed picture content and automatically generate corresponding voice description, allowing an audience to have a deeper understanding of the work through auditory and visual means. Compared with a traditional photo frame, the present disclosure brings a new interactive level to display of artistic works and enriches a viewing experience. The disadvantage that communication and an immersive experience of artistic works are limited due to only visual presentation of the works in the related art is overcome.

### BRIEF DESCRIPTION OF DRAWINGS

Accompanying drawings illustrated here are used for providing a further understanding of the present application and constitute a part of the present application. The schematic embodiments and their explanations of the present application are used for explaining the present application and do not constitute an improper limitation on the present application. In the accompanying drawings:

FIG. 1 is a schematic diagram of a composition of a photo frame in the present application.

FIG. 2 is a schematic structural diagram of an implementation model of an audio-driven facial animation of character speaking in the present application.

FIG. 3 is an exhibition method based on a photo frame in the present application.

### DETAILED DESCRIPTION

In order to make objectives, technical solutions and advantages of the present application clearer, the technical solutions of the present application will be described below clearly and completely with reference to specific embodiments of the present application and corresponding accompanying drawings. Apparently, the described embodiments are only part of the embodiments of the present application, but not all the embodiments. All other embodiments obtained by those ordinarily skilled in the art based on the embodiments in the present application without creative efforts shall fall within the protection scope of the present application.

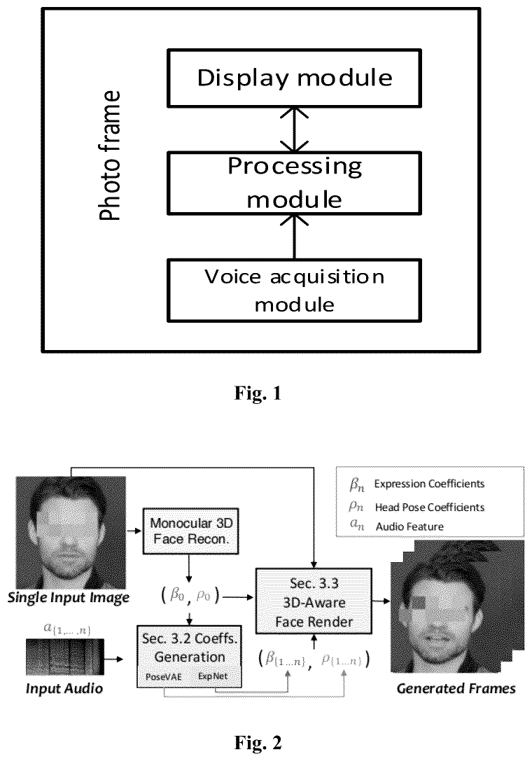

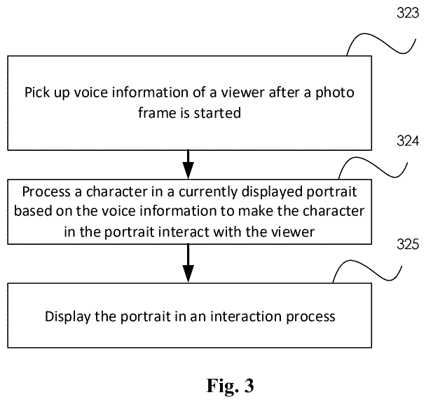

The following is an exemplary explanation of a photo frame with reference to FIG. 1. A frame body of the photo frame is an electronic display screen, the electronic display screen picks up voice information of a viewer after being started, and processes a character in a currently displayed portrait based on the voice information to make the character in the portrait interact with the viewer.

In this embodiment, an electronic display screen interface is a human-computer interaction interface, and a user may trigger an interaction operation through the human-computer interaction interface. In the interaction process, the character in the displayed portrait is processed, thereby establishing dialogue interaction between the character in the portrait and the user.

As an optional implementation of this embodiment, when the photo frame is started, a starting mode includes: receiving, if a portrait upload component in the human-computer interaction interface of a display module is triggered, an uploaded portrait and displaying the portrait; and waking up the character if the human-computer interaction interface of the display module detects that a wake-up operation of the character in the portrait is triggered, such that the processing module processes the character based on the voice information after the voice acquisition module picks up the voice information of the viewer, thereby making the character interact with the viewer.

As an optional implementation of this embodiment, the human-computer interaction interface of the display module further responds to an account login operation or an account registration operation of the user before responding to the trigger.

In the above optional implementation, a manager may log in to an account through the human-computer interaction interface and upload a to-be-displayed portrait after logging in to the account. The uploaded portrait is displayed in the human-computer interaction interface.

Further, after the portrait is displayed, a user who visits the portrait may browse and select a digital character he/she wishes to have a voice dialogue with through the human-computer interaction interface to wake up the digital character. Wake-up refers to that the digital character is in an activation state, and once a driving instruction is given, a mouth shape and limbs of the digital character are driven to perform an action.

Exemplarily, the digital character may be a character in a portrait, and when the digital character is selected, a voice dialogue interface is presented in the human-computer interaction interface. Exemplarily, when performing a wake-up operation, it may be a click operation to wake up or voice wake-up.

As an optional implementation of this embodiment, if a video upload component in the human-computer interaction interface of the display module is triggered, an uploaded video is received and displayed.

As an optional implementation of this embodiment, the human-computer interaction interface of the display module further responds to the account login operation or the account registration operation of the user before responding to the trigger.

In this optional implementation, the manager may log in to the account through the human-computer interaction interface, trigger, after logging in to the account, an interaction component in the human-computer interaction interface to upload a to-be-displayed video, and play the video through the human-computer interaction interface of the photo frame.

As an optional implementation of this embodiment, processing the character in the currently displayed portrait based on the voice information to make the character in the portrait interact with the viewer includes: processing the picked-up voice information in the interaction process, so as to determine dialogue response information corresponding to the voice information; and processing the character based on the dialogue response information, so as to drive a mouth of the character for a voice response, and/or to drive limb movement of the character while being accompanied by a language response.

In this optional implementation, in the interaction process, the viewer may ask a voice question to the photo frame, and the voice acquisition module in the photo frame may collect a voice of the user, determine a response text based on the collected voice, and generate control information for the character in the portrait based on the response text, so as to drive the character mouth shape or the limb action.

As an optional implementation of this embodiment, processing the character so as to drive the mouth of the character for the voice response, and/or to drive the limb movement of the character while being accompanied by the language response includes:
inputting audio information corresponding to the dialogue response information and the character into a trained model, and outputting a character whose character mouth shape is consistent with an audio and whose head action is consistent with the audio, wherein the trained model includes a sub network for generating the head action and a sub network for generating the character mouth shape, and output results of the two sub networks generate a plurality of image frames based on an image translation model.

In this optional implementation, refer to a schematic implementation logic diagram shown in FIG. 2. In order to learn a true three-dimensional movement coefficient of a 3DMM model from the audio, ExpNet and PoseVAE are given respectively. A new semantic decoupling and 3d perception face algorithm_x0002_ is provided, so as to generate a realistic speaking head video.

The experiment shows that this method achieves state-of-the-art performance in terms of movement synchronization and video quality.

Specifically, a character image is input to extract a head coefficient and a facial coefficient, then the head coefficient, the facial coefficient, and the audio are input into different sub networks to generate the mouth shape and the head action of the character, and further a final character image frame set that has the different mouth shapes and head actions and matches with the audio is generated based on a synthetic network, so that the character mouth shape and head action can be accompanied during audio playback.

As an optional implementation of this embodiment, training the sub network for generating the character mouth shape includes:
extracting an audio feature from an audio sample and extracting the facial coefficient from a facial image sample; and training by using the audio feature and a preset facial coefficient as inputs, and using facial mouth shape images as outputs, wherein during training, a blink correlation coefficient in the facial coefficient is redirected and introduced as an input into a training process.

As an optional implementation of this embodiment, during training, the facial image sample is input into a preset lip shape action migration algorithm for processing, and a plurality of lip shape image frames are output; and the plurality of lip shape image frames are compared with the plurality of facial mouth shape images, and training is performed with a training goal of a minimum image difference.

In this optional implementation, different audio to expressions are not one-on-one mappings for different characters. The first frame of the image is linked to a specific character through ExpNet, and there are some actions in an expression coefficient that are not related to the audio. A lip movement coefficient is obtained through wavtolip, and other facial movements are then introduced. The above features are combined together to form a mapping to obtain an output of ExpNet. In this process, due to a correlation effect of the 3DMM coefficients, each coefficient transformation often drives a plurality of different expression actions. Therefore, expnet cannot perfectly drive blinking of the character. To address this issue, the correlation between each coefficient in the 3DMM coefficients and facial expressions is explored, and a linear coefficient editing mode is used to redirect the blink correlation coefficient in the 3DMM coefficients, so as to solve the problem of head shaking caused by expnet blinking.

As an optional implementation of this embodiment, training the sub network for generating the head action includes:
extracting an audio feature from a video sample containing a character head and a human head pose feature; and inputting the audio feature, the head pose feature, and a head coefficient into an encoder, and then inputting the same to a decoder so as to output a plurality of head pose image frames, wherein training is performed with a training goal of a minimum difference between the plurality of head pose images and the input head pose feature; and the head coefficient is determined based on a preset linear adjustment coefficient.

In this optional implementation, pose VAE is used to learn realism sense and identity aware programmatic head movements of a real dialogue video. sadtalker designs an encoding and decoding structure to learn a residual of a first frame of pose, which can generate longer, more stable, and more continuous head movements. On this basis, an audio feature and style identification are added to make the head movements more stylized.

Due to the random and uncontrollable amplitude and movement direction of the head movements of poseVAE, it is prone to leading to some transitional distortions and unnatural head swings. Therefore, a set of relatively natural head swing action is designed based on the head movement coefficient of a 3DMM coefficient, a formula corresponding to the movement coefficient of each frame is as follows:

Q={θ₁x₁,θ₂x₂,θ₃x₃ . . . }
wherein, xᵢ is the 3DMM coefficient, and θᵢ is a linear adjustment coefficient of xᵢ. At this point, a head mapping is generated.

Further, when implementing an image translation model, a structure of face-vid2vid is borrowed, a MotionEncoder module is modified and replaced, and a 3DFace feature and an audio feature are input into an image generator to obtain a batch of images.

Specifically, the structure and implementation logic of the image translation model are as follows: Sadtalker is a photo driven algorithm, this type of algorithm often only focuses on the driving of the head. Therefore, when processing images with higher heads (such as a character in the figure who wears a hat or a higher headdress), it is prone to see the head moving while the hat is partially stationary. We propose using a secondary processing mode to expand a processing area of the head, and a reasoning result after expanding the processing area is combined with an original reasoning result to achieve complete head area driving.

In addition, this embodiment further improves a fusion mode of the head. The sadtalker head fusion uses a seamlessclone algorithm based on opencv for fusion. Although this method may perfectly fuse two images with different colors, a fusion effect of the seamlessclone algorithm is not necessary in this process because a color of an image driven by sadtalker is almost unchanged from a color of an original image, and the seamlessclone algorithm is only a fusion of image colors and cannot fuse image misalignment caused by the head driving of the algorithm. For this issue, the seamlessclone is replaced, a visual misalignment problem of the image is eliminated by using an edge gradient fusion mode, and a mapping processing time is saved compared to the seamlesclone mode.

Through the above optional implementation, it is possible to achieve stylized audio-driven facial animation of single image speaking using a generated realistic three-dimensional movement coefficient.

As an optional implementation of this embodiment, when determining the dialogue response information corresponding to the voice information, semantic understanding is performed on the voice information, and an intelligent model is called based on a semantic understanding result to generate the corresponding dialogue response information; and/or, preset data mapped to the currently displayed portrait is called, and the dialogue response information is modified based on the preset data.

In this optional implementation, after acquiring the voice information of the user, the monitored voice information is converted into a text, semantic recognition is performed on the converted text, a corresponding text response content is determined after recognition, and then the text response content may be converted into a voice output. When determining the response content, the intelligent model may be called to determine the response content. In order to improve the matching of responses, the preset data may be mapped to the to-be-displayed portrait in advance. When determining the response content, the response content of the intelligent model is called, and the corresponding data may be called according to the voice content. Based on the corresponding data, and then the dialogue response information is modified based on the preset data.

Further, the output voice may be rendered using a preset rendering technology to match the mouth shape of the character in the portrait with the limb action for an output.

As an optional implementation of this embodiment, after receiving the uploaded portrait and before displaying the portrait, the processing module preprocesses the portrait to adapt to an electronic display screen.

In this optional implementation, attributes of the uploaded portrait are different, so the portrait is preprocessed to adapt to the electronic screen.

The above are the devices provided by one or more embodiments of the present application. Based on the same concept, the present application further provides a corresponding exhibition method based on a photo frame, including: picking up voice information of a viewer after the photo frame is started; processing a character in a currently displayed portrait based on the voice information to make the character in the portrait interact with the viewer; and displaying the portrait in an interaction process.

As an optional implementation of this embodiment, processing the character in the currently displayed portrait based on the voice information to make the character in the portrait interact with the viewer includes: processing the picked-up voice information in the interaction process, so as to determine dialogue response information corresponding to the voice information; and processing the character based on the dialogue response information, so as to drive a mouth of the character for a voice response, and/or to drive limb movement of the character while being accompanied by a language response.

As an optional implementation of this embodiment, processing the character so as to drive the mouth of the character for the voice response, and/or to drive the limb movement of the character while being accompanied by the language response includes:
inputting audio information corresponding to the dialogue response information and the character into a trained model, and outputting a character whose character mouth shape is consistent with an audio and whose head action is consistent with the audio, wherein the trained model includes a sub network for generating the head action and a sub network for generating the character mouth shape, and output results of the two sub networks generate a plurality of image frames based on an image translation model.

As an optional implementation of this embodiment, training the sub network for generating the character mouth shape includes:
extracting an audio feature from an audio sample and extracting the facial coefficient from a facial image sample; and training by using the audio feature and a preset facial coefficient as inputs, and using facial mouth shape images as outputs, wherein during training, a blink correlation coefficient in the facial coefficient is redirected and introduced as an input into a training process.

As an optional implementation of this embodiment, during training, the facial image sample is input into a preset lip shape action migration algorithm for processing, and a plurality of lip shape image frames are output; and the plurality of lip shape image frames are compared with the plurality of facial mouth shape images, and training is performed with a training goal of a minimum image difference.

As an optional implementation of this embodiment, training the sub network for generating the head action includes:
extracting an audio feature from a video sample containing a character head and a human head pose feature; and inputting the audio feature, the head pose feature Zstyle, and a head coefficient into an encoder, and then inputting the same to a decoder so as to output a plurality of head pose image frames, wherein training is performed with a training goal of a minimum difference between the plurality of head pose images and the input head pose feature; and the head coefficient is determined based on a preset linear adjustment coefficient.

As an optional implementation of this embodiment, when determining the dialogue response information corresponding to the voice information, semantic understanding is performed on the voice information, and an intelligent model is called based on a semantic understanding result to generate the corresponding dialogue response information; and/or, preset data mapped to the currently displayed portrait is called, and the dialogue response information is modified based on the preset data.

As an optional implementation of this embodiment, when the photo frame is started, a starting mode includes: receiving, if a portrait upload component in the human-computer interaction interface of a display module is triggered, an uploaded portrait and displaying the portrait; and waking up the character if the human-computer interaction interface of the display module detects that a wake-up operation of the character in the portrait is triggered, and the processing module processes the character based on the voice information after the voice acquisition module picks up the voice information of the viewer, thereby making the character interact with the viewer.

As an optional implementation of this embodiment, when the photo frame is started, a starting mode further includes: receiving, if a video upload component in a human-computer interaction interface of the display module is triggered, an uploaded video and displaying the video.

Although the present disclosure has been described in detail with general explanations and specific embodiments in the previous text, some modifications or improvements can be made based on the present disclosure, which is obvious to those skilled in the art. Therefore, these modifications or improvements made on the basis of not deviating from the spirit of the present disclosure belong to the scope of protection claimed by the present disclosure.

What is claimed is:

1. A photo frame, wherein a frame body of the photo frame comprises a display module, a voice acquisition module, and a processing module, and after the photo frame is started, the voice acquisition module picks up voice information of a viewer; the processing module processes a character in a currently displayed portrait based on the voice information to make the character in the portrait interact with the viewer; and the display module displays the portrait in an interaction process;
wherein when the photo frame is started, a starting mode comprises:
receiving, if a portrait upload component in a human-computer interaction interface of the display module is triggered, an uploaded portrait and displaying the portrait; and
waking up the character if the human-computer interaction interface of the display module detects that a wake-up operation of the character in the portrait is triggered, and processing, by the processing module, the character based on the voice information after the voice acquisition module picks up the voice information of the viewer, such that the character interacts with the viewer;
after the portrait is displayed, a user who visits the portrait browse and select a digital character he/she wishes to have a voice dialogue with through the human-computer interaction interface to wake up the digital character. Wake-up the digital character is in an activation state, and once a driving instruction is given, a mouth shape and limbs of the digital character are driven to perform an action;
wherein processing, by the processing module, the character in the currently displayed portrait based on the voice information to make the character in the portrait interact with the viewer comprises:
processing the picked-up voice information in the interaction process, so as to determine dialogue response information corresponding to the voice information; and
processing the character based on the dialogue response information, so as to drive a mouth of the character for a voice response, and/or to drive limb movement of the character while being accompanied by a language response;
wherein processing the character so as to drive the mouth of the character for the voice response, and/or to drive the limb movement of the character while being accompanied by the language response comprises:
inputting an audio corresponding to the dialogue response information and the character into a trained model, and outputting a character whose character mouth shape is consistent with the audio and whose head action is consistent with the audio, wherein the trained model comprises a sub network for generating the head action and a sub network for generating the character mouth shape, and output results of the two sub networks generate a plurality of image frames based on an image translation model;
the image translation module using a secondary processing mode to expand a processing area of the head, and a reasoning result after expanding the processing area is combined with an original reasoning result to achieve complete head area driving; a visual misalignment problem of the image is eliminated by using an edge gradient fusion mode;
wherein training the sub network for generating the head action comprises:
extracting an audio feature from a video sample containing a character head and a human head pose feature; and
inputting the audio feature, the head pose feature, and a head coefficient into an encoder, and then inputting the same to a decoder so as to output a plurality of head pose image frames, wherein training is performed with a training goal of a minimum difference between the plurality of head pose images and the input head pose feature; and the head coefficient is determined based on a preset linear adjustment coefficient;
Wherein due to the random and uncontrollable amplitude and movement direction of the head movements, leading to some transitional distortions and unnatural head swings. Therefore, relatively natural head swing action is designed based on the head movement coefficient of a 3DMM coefficient, a formula corresponding to the movement coefficient of each frame is as follows:
Q={θ₁x₁,θ₂x₂,θ₃x₃ . . . }
wherein, xᵢ (i=1, 2, 3, . . . , n) is the 3DMM coefficient, and θᵢ (i=1, 2, 3, . . . , n) is a linear adjustment coefficient of xᵢ.

2. The photo frame according to claim 1, wherein training the sub network for generating the character mouth shape comprises:
extracting an audio feature from an audio sample and extracting a facial coefficient from a facial image sample; and
training by using the audio feature and a preset facial coefficient as inputs, and using facial mouth shape images as outputs, wherein during training, a blink correlation coefficient in the facial coefficient is redirected and introduced as an input into a training process.

3. The photo frame according to claim 2, wherein during training, the facial image sample is input into a preset lip shape action migration algorithm for processing, and a plurality of lip shape image frames are output; and
the plurality of lip shape image frames are compared with the plurality of facial mouth shape images, and training is performed with a training goal of a minimum image difference.

4. The photo frame according to claim 1, wherein determining the dialogue response information corresponding to the voice information comprises:
performing semantic understanding on the voice information, and calling an intelligent model based on a semantic understanding result to generate the corresponding dialogue response information;
and/or, calling preset data mapped to the currently displayed portrait, and modifying the dialogue response information based on the preset data.

5. The photo frame according to claim 2, wherein when the photo frame is started, a starting mode further comprises:
receiving, if a video upload component in a human-computer interaction interface of the display module is triggered, an uploaded video and displaying the video.

6. An exhibition method based on the photo frame according to claim 1, comprising: picking up voice information of a viewer after the photo frame is started;
processing a character in a currently displayed portrait based on the voice information to make the character in the portrait interact with the viewer; and
displaying the portrait in an interaction process.

7. An exhibition method based on the photo frame according to claim 2, comprising: picking up voice information of a viewer after the photo frame is started;
processing a character in a currently displayed portrait based on the voice information to make the character in the portrait interact with the viewer; and
displaying the portrait in an interaction process.

8. An exhibition method based on the photo frame according to claim 3, comprising: picking up voice information of a viewer after the photo frame is started;
processing a character in a currently displayed portrait based on the voice information to make the character in the portrait interact with the viewer; and
displaying the portrait in an interaction process.

9. An exhibition method based on the photo frame according to claim 4, comprising: picking up voice information of a viewer after the photo frame is started;
processing a character in a currently displayed portrait based on the voice information to make the character in the portrait interact with the viewer; and
displaying the portrait in an interaction process.

10. An exhibition method based on the photo frame according to claim 5, comprising: picking up voice information of a viewer after the photo frame is started;
processing a character in a currently displayed portrait based on the voice information to make the character in the portrait interact with the viewer; and
displaying the portrait in an interaction process.
